(19) United States
(12) Patent Application Publication
(10) Pub. No.: US 2016/0354730 A1
(43) Pub. Date: Dec. 8, 2016

(54) METHOD FOR THE PRODUCTION OF POLY(METH)ACRYLONITRILE-BASED POLYMER MEMBRANES, POLYMER MEMBRANES, AND ALSO SOLUTIONS FOR THE PRODUCTION OF A POLYMER MEMBRANE

(71) Applicant: FRAUNHOFER-GESELLSCHAFT ZUR FÖRDERUNG DER ANGEWANDTEN FORSCHUNG E.V., München (DE)

(72) Inventor: Detlev FRITSCH, Reinbek (DE)

(73) Assignee: FRAUNHOFER-GESELLSCHAFT ZUR FÖRDERUNG DER ANGEWANDTEN FORSCHUNG E.V., München (DE)

(21) Appl. No.: 15/101,101

(22) PCT Filed: Dec. 3, 2014
(86) PCT No.: PCT/EP2014/076414

§ 371 Date: Jun. 2, 2016

(30) Foreign Application Priority Data
Dec. 4, 2013 (DE) 10 2013 224 926.8

(51) Int. Cl. B01D 71/42; B01D 69/08; C08L 33/20; B01D 67/00

(52) U.S. Cl. CPC B01D 71/42; B01D 67/0011; B01D 67/0083; B01D 67/0095; B01D 69/087; C08L 33/20; B01D 2323/06; B01D 2323/08; B01D 2323/12; B01D 2323/22

(57) ABSTRACT

The present invention relates to a method for the production of a polymer membrane based on poly(meth)acrylonitrile, in which a poly(meth)acrylonitrile-comprising solution is used. The solution comprises a solvent for poly(meth)acrylonitrile and also a non-solvent. All of the components of the solution which are used are thereby non-toxic and do not represent chemicals which are a hazard to water. In addition, a solution which comprises a solvent for poly(meth)acrylonitrile and also a non-solvent is described. The solution is suitable in particular for implementing the method according to the invention.

The present invention relates to a method for the production of a polymer membrane based on poly(meth)acrylonitrile, in which a poly(meth)acrylonitrile-comprising solution is used. The solution comprises a solvent for poly(meth)acrylonitrile and also a non-solvent. All of the components of the solution which are used are thereby non-toxic and do not represent chemicals which are a hazard to water. In addition, a solution which comprises a solvent for poly(meth)acrylonitrile and also a non-solvent is described. The solution is suitable in particular for implementing the method according to the invention.

Polymer membranes for substance separation are generally only stable relative to a few organic solvents. Membranes which are produced from polyvinylidine fluoride (PVDF) or from polyacrylonitrile (PAN) have the best stability. These membranes are normally produced by a phase-inversion process from high-boiling solvents, such as e.g. dimethylformamide (DMF), dimethylsulphoxide (DMSO), dimethylacetamide (DMAC) or N-methylpyrrolidone (NMP).

By means of the phase-inversion process, generally membranes which have an integrally asymmetrical structure are produced. This means, viewed from the upper side (feed side) of the membrane, an increasing porosity towards the underside (permeate side). The actual separation layer of the membrane on the upper side can be adjusted by choice of solvents in principle from pore-free to pores in the micrometre range. Pore-free membranes can be used for gas separation or for nanofiltration, with increasing pore size, membranes for ultrafiltration, microfiltration are obtained. These membranes can be used directly for substance separation.

In the presence of pores of less than 50 nm, however better of less than 25 nm, the membranes are suitable in addition also as underlayer (carrier membrane) of composite membranes. As composite membranes, thin-film composite membranes are understood here, which consist in fact of this carrier and a layer applied subsequently thereon, generally a further polymer. This layer is the actual separation layer which enables the substance separation.

The requirements for gas or liquid separation are different here. For use in gas separation, a flow of the carrier membrane of at least 10-times greater than the end flow of the composite membranes is required. Generally, gas flows greater than 100 m³/m²hbar are required here. For liquid applications, such as ultra- or nanofiltration, generally water flows of >50 l/m²hbar are sufficient. In principle, higher flows with small average pore sizes imply higher porosity and should be striven for.

Composite membranes consist of a porous carrier membrane on which the actual separation layer is applied by known methods, such as spraying, printing, roller application, nozzle coating or injection- or immersion methods. This separation layer generally consists of a second polymer which delivers the selectivity. In order to achieve sufficient throughput for commercial application, this separation layer must be applied as thinly as and defect-free as possible. The typical thickness, according to application and material, is between 50 and 1,000 nm. This separation layer can be made, in addition, solvent-stable or ageing-resistant by suitable methods, such as e.g. crosslinking techniques.

In WO 2007/0125367, nanoporous membranes are produced from polyimides, which membranes display a cut-off value below 500 g/mol and are suitable in principle as carrier material for composite membranes. However, the pores of these membranes must be protected from collapsing. For this purpose, the membranes are impregnated with hygroscopic substances, such as glycerine or low-molecular polyethylene glycols. In general, this prevents use as carrier material for composite membranes since this treatment prevents defect-free coating. Furthermore, the membranes, in order to be stable relative to solvents, must be crosslinked in a second step with suitable di- or polyamines. Furthermore, these membranes have no stability in basic pH values>pH=9 since the polyimide structure is attacked and the membranes are destroyed.

Polysulphone is a very well suited polymer for adjusting the pore size, porosity and hence the separation properties. In EP 0 362 588 A1, pouring solutions for example which lead to porous membranes are disclosed. However, here NMP is used as base solvent which is classified as dubious according to the REACH process. The indicated pore sizes are in the range of 100-220 nm and the bubble point is at 2-3 bar. The membranes pores are protected in addition from collapsing with glycerine. By varying the production conditions, smaller pores are probably possible and the bubble point can be raised in order to improve the coatability. However, polysulphone, particularly the fine-porous uppermost layer of the membrane, has only low resistance relative to frequently used coating solvents. Hence, polysulphone is less well suited as base polymer for composite membranes.

Polyvinlyidine fluoride has good resistance relative to many low-boiling solvents, and porous membranes which are also suitable for the production of composite membranes were investigated intensively [F. Liu, N. A. Hashim, Y. Liu, M. R. M. Abed, K. Li, Progress in the production and modification of PVDF membranes, J. Membr. Sci., 375 (2011) 1-27]. In general, membranes with relatively large pores are however produced here or the pouring solutions comprise salts, such as LiCl, or solvents, such as 1-octanol, are added to the precipitation bath. Furthermore, membranes made of unmodified PVDF are strongly hydrophobic, for which reason coatings made of many membrane polymers adhere only poorly and are not usable as separation membrane for long-term use.

Membranes made of polyacrylonitrile were described in the literature. In DE 195 46 836 and DE 195 46 837, capillary membranes which can be used in osmometry are described. Preferably, a PAN with a copolymer proportion<1% by weight is used since here better solvent stability is present. As solvent for the precipitation process, N-methylpyrrolidone (NMP) with the addition of gamma-butyrolactone (GBL) or mixtures with N,N-dimethylacetamide (DMAC) are used. The desired porosity and pore size is obtained by addition of NMP to the precipitation bath. Both the addition of solvent to the precipitation bath and the solvents used should be avoided according to the REACH process.

In DE 43 25 650, polyacrylonitriles with a fairly high comonomer proportion are used. According to the invention there: “it is essential to the invention that the pouring or extrusion solution for the production of the membrane according to the invention is produced using NMP, NMP mixtures, DMAc/DMF mixtures or DMSO/DMF mixtures as solvent. NMP can hereby be used as such or as mixed solvent with a content of at least 50% by weight of NMP. In the case of use as mixed solvent, in addition to NMP, also other polar, aprotic solvents from the group y-butyrolactone, propylene carbonate, N-methylcaprolactam (NMC) and N—C₁-C₄-alkyl morpholine, DMF, dimethylsulphoxide (DMSO), DMAc, N—C₂-C₄-alkyl- or N-hydroxy-C₁-C₄-alkylpyrrolidone, are used alone or, for their part, as a mixture.” These solvents should be avoided apart from DMSO according to the REACH process.

In DE 698 31 305, hollow fibres are produced from PAN for filtration and have a complete foam structure. For this purpose, the solvent propylene carbonate is added to the solvent DMSO and mixed with polyethylene glycol of a low molar mass as non-solvent in order to keep close to the precipitation limit. The polymer concentration was >18% and a high-molecular PAN was used. A very high viscosity with which hollow fibres can be produced results therefrom. For flat membranes, a pourable solution is generally required. Propylene carbonate is an important component of the pouring solution in DE 69831305. Without this substance, it is described as difficult to obtain a membrane with the desired properties. This composition of the pouring solution is not usable for flat membranes because of the high viscosity. Other swelling means or non-solvents must therefore be found. Membranes produced without the addition of swelling means or non-solvents and made from the pure solvents DMF, DMAC or DMSO in fact produce membranes. However, these have very large caverns which appear as far as just below the separation layer. Hence the danger of defects is greatly increased and the entire membrane is not suitable for use under high pressure.

Furthermore, polyacrylonitrile membranes are described in the literature [N. Scharnagl, H. Buschatz, Polyacrylonitrile (PAN) membranes for ultra- and microfiltration, Desalination, 139 (2001) 191-198]. Here, a PAN with little comonomer proportion is used and the solvent consists of pure DMF. The pore size can be adjusted via the concentration of the pouring solution and the temperature of the precipitation bath, pressure-stable membranes being obtained. The solvent DMF should be avoided according to the REACH process. Furthermore, temperatures above room temperature (RT) should be avoided because the vapour pressure of the precipitant water is consequently increased and poorly reproducible precipitation processes can occur even before immersion in the precipitation bath. At temperatures below RT, additional costs arise, which can be avoided.

All of the solvents used in the previously presented methods, such as for example NMP, DMF or DMAc, represent however chemicals with a high hazard potential. Thus, these chemicals are partially inflammable and have mutagenic potential. In particular in the case of temperature-controlled precipitation baths, spinning solutions or drying steps, these chemicals change into the gas phase so that great safety precautions must be taken in order to prevent these chemical vapours either coming in contact with a user or passing into the environment. Also disposal of these spinning solutions etc. represents a great problem.

Starting herefrom, it is hence the object of the present invention to find a solvent or solvent mixture for polyacrylonitrile which, in composition, comprises only substances which are classified as unproblematic according to the REACH process. At the same time, the performance of the membranes produced in this way should however not be impaired.

The object of the invention resides therefore in particular in producing a porous carrier membrane with the properties
gas flow>100 m³/(m²*h*bar)
average pore size<25 nm
pressure stability>30 bar
   made of polyacrylonitrile.

This membrane, in the dry and wet state, should be coatable with polymers made from solvents which do not noticeably swell or even dissolve the polyacrylonitrile.

This object is achieved with the method according to patent claim 1, patent claim 7 provides a polymer membrane according to the invention, whilst patent claim 13 concerns a solution for the production of a polymer membrane. The respectively dependent patent claims thereby represent advantageous developments.

According to the invention, a method for the production of a polymer membrane is hence indicated, in which a solution, comprising or consisting of
a) poly(meth)acrylonitrile, a copolymer based on (meth)acrylonitrile or mixtures hereof,
b) dimethylsulphoxide (DMSO) as solvent for poly(meth)acrylonitrile or a copolymer based on (meth)acrylonitrile, and also
c) at least one non-solvent in which poly(meth)acrylonitrile or the copolymer based on (meth)acrylonitrile does not dissolve and which is miscible with the solvent,
   the solution being free of crosslinkers for poly(meth)acrylonitrile or copolymers based on (meth)acrylonitrile, being poured as a film or spun to form a hollow fibre, the poly(meth)acrylonitrile, copolymer based on (meth)acrylonitrile or the mixture hereof being precipitated by a phase-inversion process and the poly(meth)acrylonitrile, copolymer based on (meth)acrylonitrile or the mixture hereof being stabilised by temperature treatment at temperatures increased relative to room temperature.

According to the invention, it was surprisingly found that excellent membranes could be produced even from solutions which comprise exclusively solvent or non-solvent which are safe, polymer membranes based on poly(meth)acrylonitrile, which membranes have optimum distribution of the cavities within the membrane and also a high gas flow rate.

The membrane can hence be produced according to the phase-inversion process. Surprisingly, it was shown that, even when using exclusively solvents which are not a hazard to water or only to a small extent and which are easily biodegradable, excellent results can be achieved. In the choice of solvents for the phase-inversion process, only solvents which are classified as non-problematic according to the European Chemicals Regulation REACH were used. The precipitation bath in which the phase-inversion is implemented can preferably consist exclusively of water which is possibly temperature-controlled.

Furthermore, the membrane is intended to be precipitated exclusively in water without additives, the water temperature being intended to be in the range of 15-25° C. during the precipitation process. The properties of the membrane according to the invention should permit use as carrier membrane for composite membranes, the carrier membrane being able to be coated in the dry or wet state. Impregnation agents for protecting the pore structure from change during drying need not be used.

The term poly(meth)acrylonitrile thereby stands for polyacrylonitriles which can be substituted by a methyl group possibly on the vinyl group and hence includes both polyacrylonitrile and polymethacrylonitrile. Copolymers based on (meth)acrylonitrile are thereby derived essentially from the monomeric (meth)acrylonitrile, i.e. these polymers are preferably derived at at least 80% by mol from (meth)acrylonitrile. Polyacrylonitrile is thereby particularly preferred.

The solution used according to the invention is thereby free of crosslinkers of poly(meth)acrylonitrile, i.e. in particular free of amino group-containing polymers which can be selected for example from the group consisting of polyethylene imine (PEI), polyvinyl amine, polyallyl amine and/or mixtures or combinations hereof, the polyethylene imine (PEI), polyvinyl amine or polyallyl amine preferably having a number-average molecular weight Mw of 25,000 to 750,000 g/mol.

In the case where a flat membrane is produced, the solution is poured as a film. In the case where a hollow fibre membrane is produced, the solution is spun through an annular nozzle. In principle, it is hereby conceivable that air-spinning is effected, i.e. that, before introduction into the precipitation bath, the produced hollow fibre, which is produced by the annular nozzle, is transported in the direction of the precipitation bath via an air gap, it is likewise possible that direct spinning of the hollow fibre into the spinning solution itself is effected. In the case of production of a hollow fibre by spinning the solution according to the invention, it is likewise possible that the hollow fibre is introduced already into a hot precipitation bath, the precipitation bath can hereby have for example temperatures of 80 to 99° C., preferably 90 to 97° C., in particular approx. 95° C. Upon entry of the hollow fibre into the precipitation bath, precipitation of the polymer membrane hereby already takes place.

Stabilisation is achieved by temperature treatment of the obtained film or hollow fibre, it is thereby achieved according to the invention that a completely homogeneously configured film or hollow fibres is achieved.

In the case where a flat membrane is intended to be produced, it is preferred if the film is poured onto a substrate. In particular onto a nonwoven made of a polymeric material, preferably polyester. This embodiment is advantageous in particular since, on the one hand, continuous transport of the polymer membrane applied on the flow material through the precipitation bath or through a further bath is possible, on the other hand, a finished composite membrane can be produced in one step.

Furthermore, the film or hollow fibre obtained after the phase-inversion process can be washed with water.

The temperature treatment used for stabilisation is thereby implemented advantageously at temperatures of 50 to 150° C., preferably of 70 to 120° C., particularly preferably of 85 to 99° C.

It is thereby particularly preferred and according to the invention if, directly following the precipitation step and/or the possibly effected washing step, the temperature treatment is also implemented. According to a particularly preferred embodiment of the present invention, a water bath is used for this purpose, which water bath has a temperature of more than 50° C., preferably 50 to 99° C., further preferably 70 to 99° C.°, in particular 85 to 95° C. For example, it is possible that the continuously produced films or hollow fibres are discharged out of the precipitation bath and introduced into a temperature-controlled water bath. This can be effected for example by means of machines for the membrane production which are suitable and known from the state of the art for this purpose. Alternatively, it is likewise possible to implement the method continuously. The steps of precipitation, stabilisation/washing, drying can be effected in one machine and a dry membrane according to the invention is obtained. It can also be provided for example that the produced films or hollow fibres are firstly removed from the precipitation bath and rolled onto a corresponding storage roller and the roller itself is temperature-controlled, for example in a water bath. It is in addition particularly advantageous during implementation of the temperature-controlling step in the water bath that possibly any solvent still present in the produced polymer membrane is thereby completely washed out.

The temperature treatment is thereby implemented advantageously over a period of time of 5 min to 24 hours, preferably 15 min to 12 hours, particularly preferably of 20 to 60 min.

Possibly after stabilisation and/or the washing step, drying of the membrane can be implemented, preferably in an air flow at a temperature between 60 and 150° C., preferably between 60 and 120° C., particularly preferably between 80 and 110° C. or between 110 and 130° C.

In principle, it is however likewise conceivable that the stabilisation step is implemented during the drying step, preferably as described above.

In addition, the present invention relates to a polymer membrane which can be produced as described above.

The membrane can thereby be configured in principle as a film, likewise it is conceivable that the membrane has the form of a hollow fibre.

Preferably, the thickness of the membrane, without any possibly present substrate, is of 20 to 200 μm, preferably of 40 to 90 μm.

The thickness of the membrane thereby refers either to the layer thickness of the film or to the thickness of the wall of the hollow fibre.

In the case where a further substrate is present, this is preferably a nonwoven, in particular a polyester nonwoven.

The presence of a substrate, for example a nonwoven, in particular a polyester nonwoven, is thereby preferred in particular in the case of film membranes.

Preferably, the membrane has pores, the pore size at the bubble point being at 15 to 100 nm, preferably at 20 to 100 nm, particularly preferably at 30 to 50 nm or 20 to 40 nm. The bubble point of the membranes is in the range of 6 to 32 bar, preferably 6 to 20 bar or 16 to 32 bar, particularly preferably 15 to 20 bar. For example, this corresponds to a pore size at the bubble point of 40 nm (at 16 bar) to 20 nm (at 32 bar). For determination of the bubble point, a porometer (Porolux®500) was used. The bubble point is indicated in the case of the first measurable flow and corresponds to the largest pore, the pore at the bubble point. The average pore size is determined as the pore size in the case of 50% of the total flow. The bubble point represents a measure of the quality of the obtained membrane in conjunction with the average pore size. For example, an average pore size of 30 nm at the bubble point, in the case of an average pore size of 20 nm, represents a very good membrane. A pore size at the bubble point of 150 nm, in the case of an average pore size of 20 nm, represents a rather poor membrane. Alternatively hereto, the pore size always corresponds to a pressure which is applied to the membrane for measurement. In this respect, it is likewise possible to define the pore size directly via the bubble point as a function of a pressure. A preferred pore size can hence be defined via the bubble point test. The pressure is hereby preferably >6 bar (which corresponds to a pore size of approx. 100 nm), preferably greater than 10 bar (which corresponds to a pore size of approx. 60 nm) or particularly preferably >20 bar (which corresponds to a pore size of <32 nm).

The bubble point describes the largest pore and hence a measure of defects in the membrane. The quality of the membrane has hence two characteristic values:
1) the bubble point
2) average pore size

According to the first criterion, in fact defects are measured, according to the second criterion, i.e. the actual porosity of the membrane. The throughflow of the membrane for gases at the bubble point is typically <0.01% of the flow in the case of the average pore size.

Preferred average or mean pore sizes of the membrane according to the invention are thereby of 15 to 30 nm, preferably of 18 to 25 nm.

The pores are thereby produced automatically in the precipitation step or in a subsequent washing step and fixed by the stabilisation step.

The nitrogen permeability JN2 of the polymer membrane according to the invention is thereby preferably 10 to 1,000 m³/(m²·h·bar). Determination of the nitrogen permeability is effected with a gas burette. The gas flow is thereby measured per unit of time and is related to the surface area and the pressure. Alternatively, the use of a gas measuring device, e.g. Definer 220 by BIOS, is likewise suitable for determining the gas flow. Likewise, it is possible to determine the measurement of the gas flow at 3 bar, with a porometer (e.g. Porolux®500).

The pores are thereby disposed in a foam structure, preferably asymmetrically from the upper side to the underside of the membrane with increasing pore size. The membrane can also have caverns in the lower region. The foam structure is configured at least with a thickness of 2 μm. Advantageously, the foam structure is 10-40 μm up to caverns or the membrane is free of caverns. The membrane structure is examined with scanning electron micrographs.

In addition, the invention relates to a solution for the production of a polymer membrane, comprising or consisting of
a) poly(meth)acrylonitrile, a copolymer based on (meth)acrylonitrile or mixtures hereof;
b) at least one solvent for poly(meth)acrylonitrile or a copolymer based on (meth)acrylonitrile in which the previously mentioned components are present in dissolved state; and also
c) at least one non-solvent in which poly(meth)acrylonitrile or the copolymer based on (meth)acrylonitrile does not dissolve and which is miscible with the solvent,
   the solution being free of crosslinkers for poly(meth)acrylonitrile or copolymers based on poly(meth)acrylonitrile.

In a particularly preferred embodiment, the non-solvent is selected from the group consisting of acetone, diacetone alcohol, ethyl lactate, 1,3-dioxolane, polyalkylene glycol, in particular polyethylene glycol, tetraalkylene glycol, in particular tetraethylene glycol, alcohols, in particular isopropanol, ethanol, water and also mixtures hereof.

Further advantageously, the total content of poly(meth)acrylonitrile, of the copolymer based on (meth)acrylonitrile or mixtures hereof, relative to the solvent and also possibly the sum of solvent and non-solvent, is of 1 to 30% by weight, preferably 5 to 20% by weight, particularly preferably 7.5 to 15% by weight.

The content of non-solvent, relative to the content of solvent or of the mixture of at least two solvents, is thereby preferably 10 to 60% by weight, preferably 15 to 45% by weight.

According to a particularly preferred embodiment, the polymer which is used is polyacrylonitrile. Preferred copolymers are obtainable by copolymerisation of (meth)acrylonitrile with at least one copolymer, selected from the group consisting of (meth)allyl sulphonic acid or the salts thereof.

The solution thereby has a preferred viscosity of 1.5 to 20 Pa·s, preferably 4 to 12 Pa·s or 2 to 10 Pa·s.

The present invention is described in more detail with reference to the subsequent embodiments, Figures and also examples, without restricting the invention to the illustrated special parameters.

The Figures thereby show:

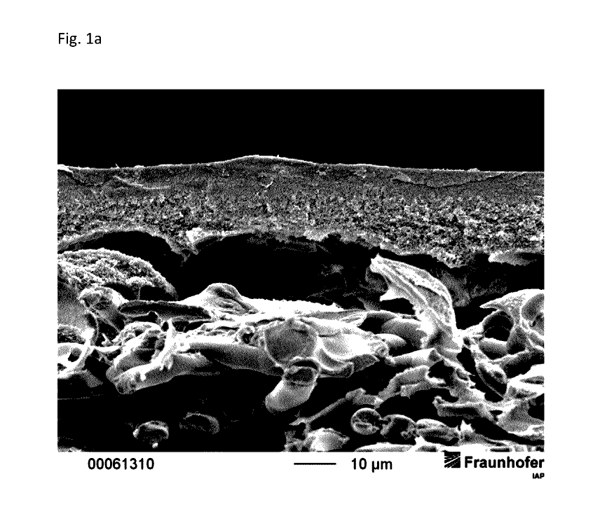

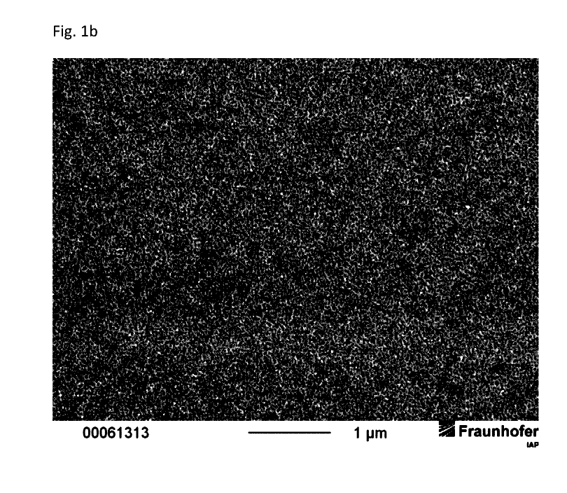

FIG. 1a cross-section membrane D, table 3 (DMSO/acetone 4/1).

FIG. 1b surface membrane D, table 3 (DMSO/acetone 4/1).

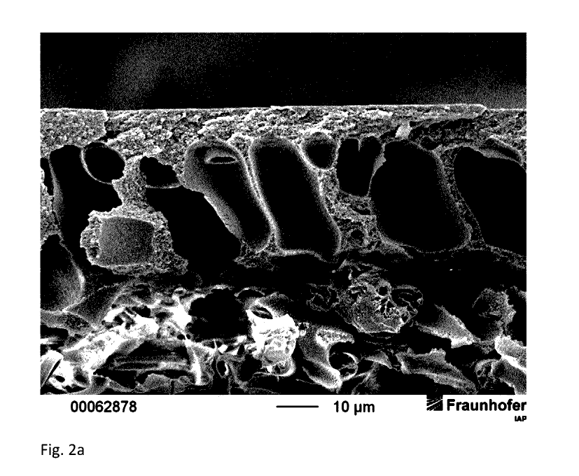

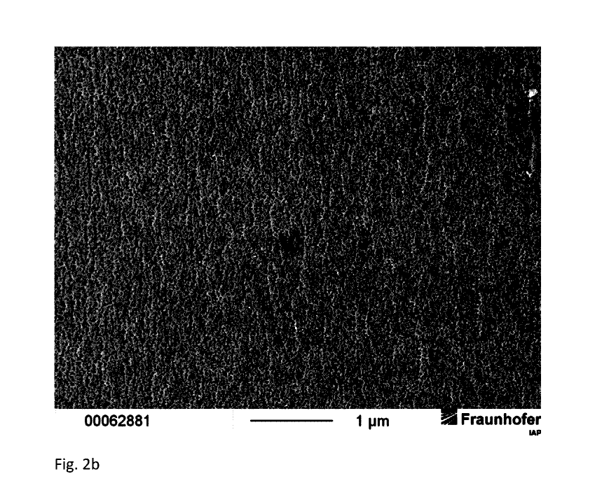

FIG. 2a cross-section membrane H, table 3 (DMSO/acetone 7/3).

FIG. 2b surface membrane H, table 3 (DMSO/acetone 7/3).

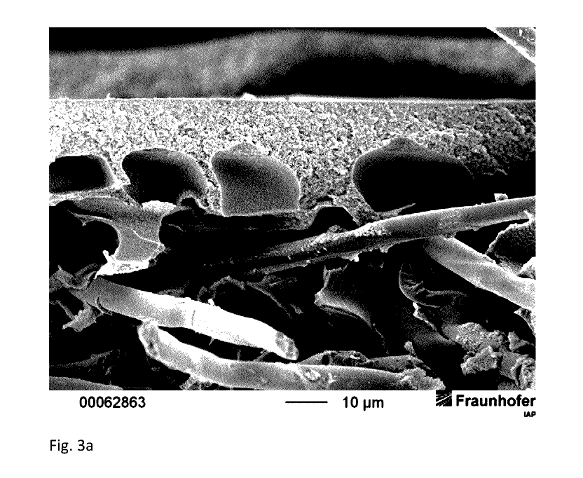

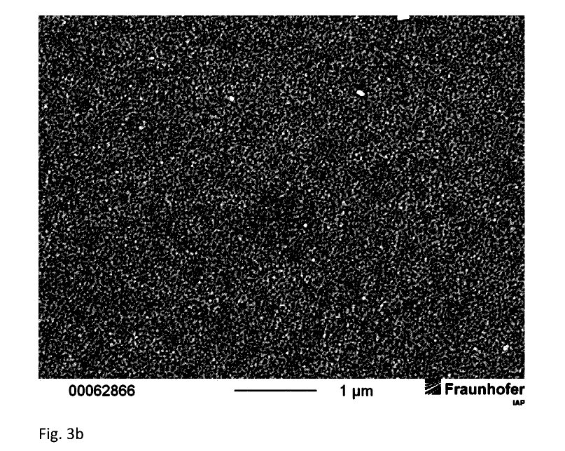

FIG. 3a cross-section of membrane 2 from example 2 (DMSO/diacetone alcohol).

FIG. 3b surface of membrane 2 from example 2 (DMSO/diacetone alcohol).

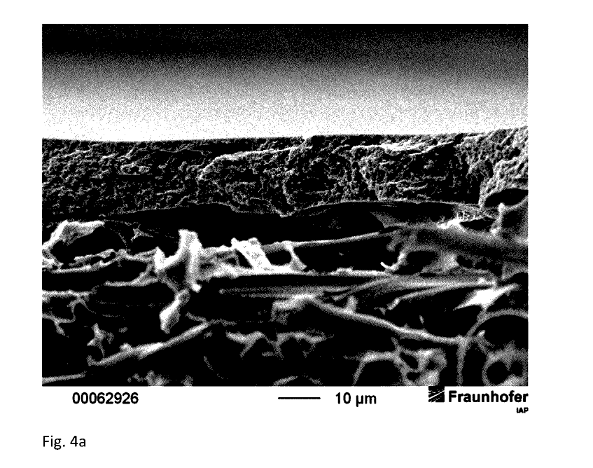

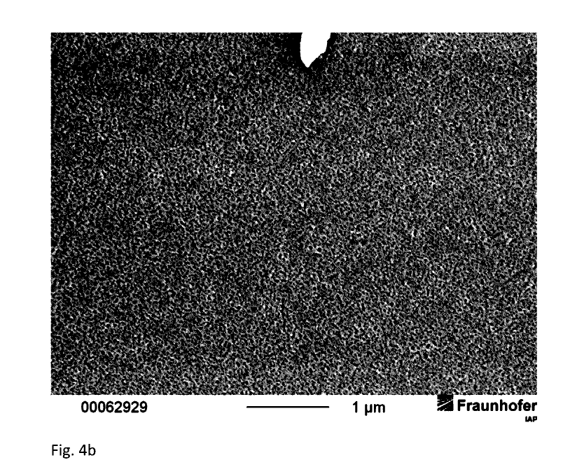

FIG. 4a cross-section of the membrane from example 3 (DMSO/ethyl lactate).

FIG. 4b surface of the membrane from example 3 (DMSO/ethyl lactate).

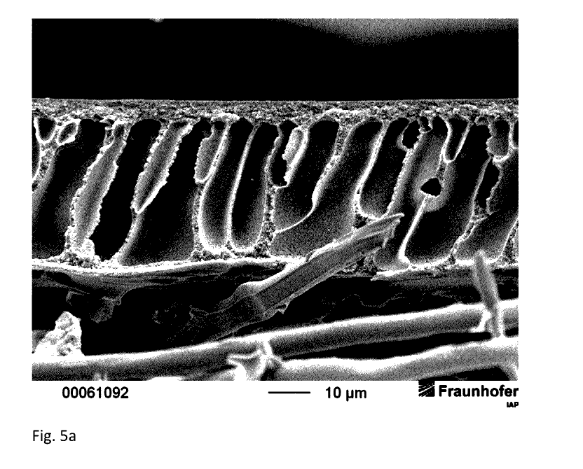

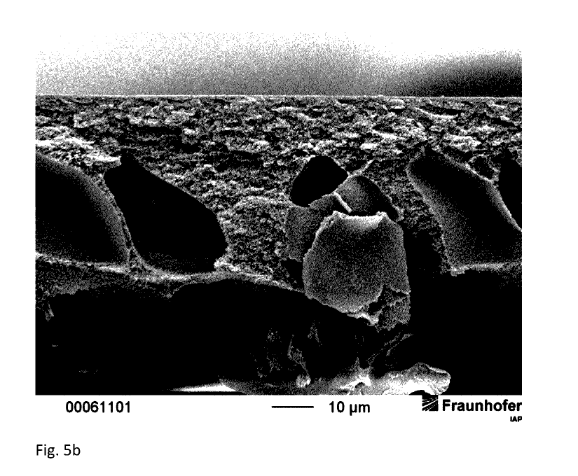

FIG. 5a cross-section of membrane B from example 4, tables 5, 6 (DMSO/1,3-dioxolane).

FIG. 5b cross-section of membrane D from example 4, tables 5, 6 (DMSO/1,3-dioxolane).

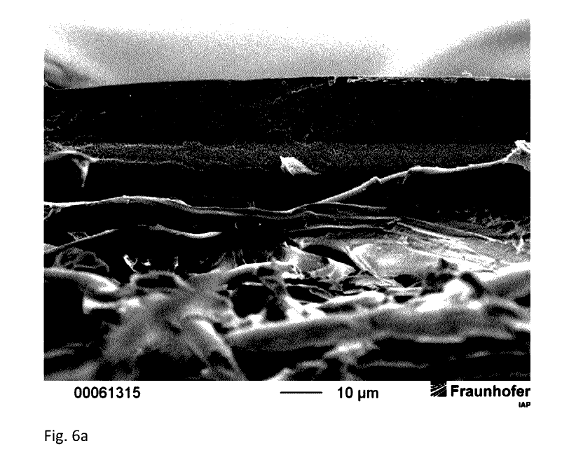

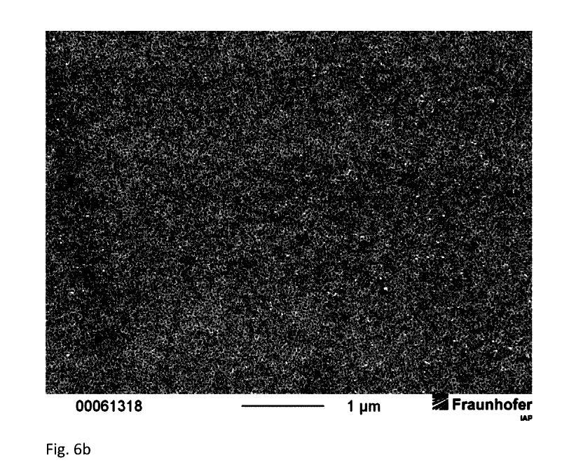

FIG. 6a cross-section of membrane F from example 4, tables 5, 6 (DMSO/1,3-dioxolane).

FIG. 6b surface of membrane F from example 4, tables 5, 6 (DMSO/1,3-dioxolane).

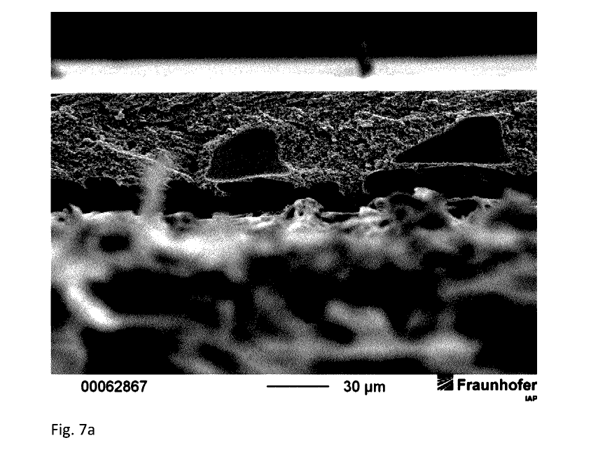

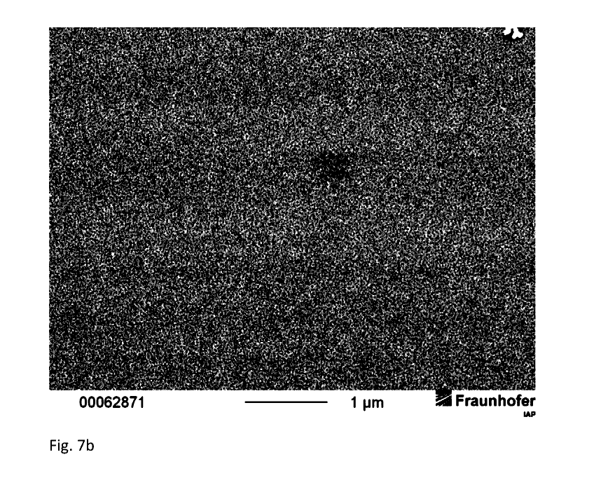

FIG. 7a cross-section of membrane I from example 4, tables 5, 6 (DMSO/1,3-dioxolane).

FIG. 7b surface of membrane I from example 4, tables 5, 6 (DMSO/1,3-dioxolane).

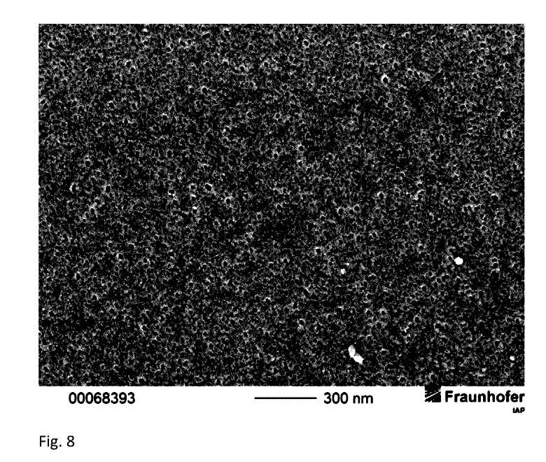

FIG. 8 high-resolution surface of the membrane from PS no. 3 from example 5, table 9 (DMSO/1,3-dioxolane).

Polyacrylonitrile is a polymer which can be used readily for polymer membranes, which polymer has good solvent stability as homopolymer and nevertheless can be processed to form fibres or membranes from some high-boiling solvents by means of the phase-inversion process. Frequently used solvents for PAN are, e.g. dimethylacetamide (DMAC), dimethylformamide (DMF), ethylene carbonate, y-butyrolactone (GBL), N-methylpyrrolidone (NMP). For commercial fibre-spinning processes, also aqueous solutions of salts, such as sodium thiocyanate (NaSCN) and zinc chloride or nitric acid are used. Dimethylsulphoxide (DMSO) is used in fibre spinning only to a lesser extent [see A. Nogaj, C. SUling, M. Schweizer, Fibers, 8. Polyacrylonitrile Fibers, in: Ullmann's Encyclopedia of Industrial Chemistry, Wiley-VCH Verlag GmbH & Co. KGaA, 2000].

The methods used in the literature for the production of PAN membranes are generally based on the solvents DMF and NMP. More rarely, DMAC is used. The membrane to be produced should have as extensive a foam structure as possible in order to ensure high pressure stability. Pressures up to 80 bar are common in reverse osmosis and can also be required in nanofiltration and also in gas- or vapour separation for an economical process.

For the membrane production, a mixture of solvent and swelling means or non-solvents is used according to the known methods. DMSO was selected here as base solvent since it should be regarded, according to the REACH regulations, as the best choice compared with DMF, NMP and DMAC or sulfolane.

Additives must therefore be found which act as swelling means or non-solvents and bring the polymer solution close to the precipitation limit. Furthermore, these substances should display high to complete water miscibility, be non-toxic and easily biodegradable.

For comparison, membranes were produced from the pure solvents DMF, DMAC and DMSO according to the normal methods. From all these pure solvents, only a thin top layer is formed on the upper side of the membrane with large caverns situated closely thereunder.

### EXAMPLES

Two types of polyacrylonitrile were used:
PAN-1: acrylonitrile (93.5%) methacrylate (6%) sodium methallyl sulphonate (0.5%) copolymer.
Inherent viscosity (DMF) 140 cm³/g.
PAN-2: polyacrylonitrile homopolymer (99.5% acrylonitrile). Inherent viscosity (DMF) 194 cm³/g.

There were used as solvents and solvent additives:

dimethylsulphoxide (DMSO), acetone, 4-hydroxy-4-methyl-pentan-2-one (diacetone alcohol), 1,3-dioxolane (DIOX), tetraethylene glycol (TEG), polyethylene glycol 200 (PEG) and ethyl lactate.

Viscosity:

For the pouring solutions, the dynamic viscosity is measured with a rotational viscosimeter DIN/ISO-viscosimeter 550 (of Thermo Haake). The value at a speed of rotation of 100 rpm is indicated in Pa*s.

SEM: scanning electron micrograph. Breakage in liquid nitrogen or surface, both sputtered with Au.

Porometer: a porometer Porolux® 500 was used. The bubble point is indicated in the case of the first measurable flow and corresponds to the largest pore. The average pore size is the pore size at 50% of the total flow.

Nitrogen flow: the gas flow is interpolated at 3 bar from the porometer measurements of the dry curve and indicated in m³/(m²*h*bar). Averages of 3-5 test pieces are indicated.

% data: the percentage data are % by mass.

As underlayer on the membrane-drawing machine for the continuous production process, a polyester nonwoven (PET) with a basis weight of approx. 100 g/m² and a thickness of 160 μm was used.

Membrane Production:

An 8-15% polymer solution was produced from solvent or solvent mixtures. If required, heating takes places up to approx. 100° C. in order to produce the solution. The clear solution is filtered at RT via a wire fabric with 25 μm pore width under nitrogen pressure and left to stand for approx. 16 h for degassing at RT. The thus treated polymer solution is applied onto a polyester nonwoven via a doctor blade on a membrane-drawing machine and precipitated in the precipitation bath in water of 20 to 22° C. The membrane is washed in a washing bath at approx. 40° C. for 2-3 h, washed for a further 30 min at 90-95° C. and dried in the air flow at 120° C. for 2 h. The thus manufactured membrane is storable and ready for use without further treatment.

### Example 1

### Membranes Made of DMSO with Acetone as Non-Solvent

Table 1 indicates the composition of 9 pouring solutions. Membranes, as described under membrane production, were produced therefrom whilst varying the method parameters. The gap height varied between 200 and 250 μm and was, in the case of the membranes from table 2 for membranes A, B, L, at 250 μm, in the case of C, F at 225 μm and in the case of D, E, G-K at 200 μm. The drawing rate was, in the case of A, B, at 2 m/min and in the case of B-L, at 1 m/min. The precipitation bath temperature was at 20-23° C. Membranes A, B were washed with water of 19° C. for 40 h, C, D at 38° C. for 16 h, E-L at 38° C. for 2 h. The membranes C-L were washed in addition, after washing, at 95° C. for 0.5 to 0.75 h in water. All of the membranes were dried, after washing, for 2 h at 105° C. (A, B, C) or at 120° C. (D-L). With a porometer, the nitrogen flows were measured at approx. 3 bar, the pore size at the bubble point (BP) and the average pore size of the membranes. Scanning electron micrographs produced information about the inner membrane structure and the pore size.

TABLE 1

| PS | | Polymer, | DMSO, | Acetone, | Weight ratio | Polymer, | Viscosity, |
|---|---|---|---|---|---|---|---|
| no. | Polymer | g | g | g | DMSO/acetone | % | Pa*s |
| 1 | PAN-1 | 13.0 | 69.6 | 17.4 | 4/1 | 13.0 | 2.0 |
| 2 | PAN-2 | 10.2 | 69.6 | 17.4 | 4/1 | 10.5 | 7.2 |
| 3 | PAN-2 | 22.0 | 142.4 | 35.6 | 4/1 | 11.0 | 9.2 |
| 4 | PAN-2 | 18.0 | 113.4 | 48.6 | 7/3 | 10.0 | 4.5 |
| 5 | PAN-2 | 27.0 | 182.2 | 60.8 | 3/1 | 10.0 | 5.4 |
| 6 | PAN-2 | 16.5 | 93.5 | 40.0 | 7/3 | 11.0 | 6.9 |
| 7 | PAN-2 | 16.1 | 107.0 | 26.8 | 4/1 | 10.75 | 7.4 |
| 8* | PAN-2 | 16.2 | 107.0 | 27.0 | 4/1 | 10.75 | 7.8 |
| 9 | PAN-2 | 27.3 | 140.0 | 60 | 7/3 | 12.0 | 10.8 |

*No. 8 comprises in addition 0.7 g Texanol.

As is evident from table 1, the viscosity, in the case of all of the pouring solutions, was in the flowable range of 2 to 11 Pa*s. In the case of PAN-1 (table 1, no. 1) the concentration can be chosen to be even higher in order to achieve optimum viscosity in the range of 5-10 Pa*s. Increasing the proportion of acetone lowers the viscosity with the same polymer concentration. The addition of Texanol increases the viscosity slightly (table 1, nos. 7, 8).

From the pouring solutions of table 1, membranes A-L were produced and the production parameters and properties were compiled in tables 2, 3. The membranes A, B were washed only at 40° C., as a result of which the pore structure was not sufficiently stabilised. After drying, only N2 flows which were below 5% of the average flows of the membranes washed at 95° C. were found.

The suitability of the membranes as composite membranes is determined by a gas flow>100 m³/(m²*h*bar), an average pore size (MFP) of <25 nm and a bubble point (BP) which should be <50 nm. The gas flow, in the case of membranes C-L, is two to four times greater than the target value 100 m³/(m²*h*bar). The MFP is, at 25 to 20.5 nm, well within the desired range. The BP is partially greater than 50 nm.

TABLE 2

| Pouring | | | | | | | |
|---|---|---|---|---|---|---|---|
| solution | | | JN2, | MFP | Standard | | Standard |
| no. | Membrane | Gap, | m³/ | size, | deviation | BP pore | deviation |
| (tab. 1) | no. | μm | (m²*h*bar) | nm | MFP, nm | size, nm | BP, nm |
| 1 | A* | 250 | 12 | | | | |
| 2 | B* | 250 | 1 | | | | |
| 3 | C | 225 | 210 | 20.5 | 0.3 | 29.1 | 2.6 |
| 3 | D | 200 | 420 | 22.7 | | 40 | |
| 4 | E | 200 | 370 | 23.6 | 0.7 | 30 | 4.2 |
| 4 | F | 225 | 360 | 23.5 | 1.1 | 40.6 | 8.3 |
| 5 | G | 200 | 400 | 23.5 | 2.1 | 36.5 | 7.9 |
| 6 | H | 200 | 280 | 24.3 | 0.9 | 90 | 28 |
| 7 | I | 200 | 375 | 24.8 | 0.9 | 98 | 25 |
| 8 | J | 200 | 300 | 24.7 | 0.9 | 105 | 18 |
| 9 | K | 200 | 205 | 20.9 | 0.1 | 93 | 41 |
| 9 | L | 250 | 280 | 23.5 | 0.8 | 115 | 88 |

*washed only at 40° C.

The electron-microscopic examination of the membranes allows a look at the inner structure of the membrane. In order to avoid defects, the foam structure should comprise more than 10% of the membrane thickness, better 20% or complete foam structure without caverns or hollows in the membrane. Membranes H-K achieve 20% foam structure with an absolute thickness of the foam of approx. 10 μm. Membrane D is completely free of caverns. By varying the gap height (see table 3 membrane K, L), the absolute membrane thickness and the proportion of foam can be controlled. In FIG. 1a, b, the structure of membrane D from table 3 is illustrated in cross-section (FIG. 1a) and the surface (FIG. 1b). The membrane is completely free of caverns. In FIG. 2a, b, the structure of membrane H is illustrated in cross-section (FIG. 2a) and the surface (FIG. 2b). Approx. 80% of the membrane thickness is formed by caverns. The foam structure is sufficiently strong to avoid defects in the membrane production and to ensure sufficient pressure stability.

TABLE 3

| Pouring | | | Spacing | Membrane | |
|---|---|---|---|---|---|
| solution no. | Membrane | J_{N2}, | cavern, | thickness, | % |
| (table 1) | no. | m³/(m² * h * bar) | μm | μm | foam |
| 1 | A* | 12 | 0.44 | 80 | 0.6 |
| 2 | B* | 1 | — | — | |
| 3 | C | 210 | 4 | 69 | 6 |
| 3 | D | 420 | 20 | 20 | 100 |
| 4 | E | 370 | 4 | 60 | 7 |
| 4 | F | 360 | 4 | 75 | 5 |
| 5 | G | 400 | 4 | 50 | 8 |
| 6 | H | 280 | 8 | 45 | 18 |
| 7 | I | 375 | 8 | 47 | 17 |
| 8 | J | 300 | 10 | 45 | 22 |
| 9 | K | 205 | 8 | 45 | 18 |
| 9 | L | 280 | 8 | 70 | 11 |

*washed only at 40°

### Example 2

### Membrane Made of DMSO with Diacetone Alcohol as Non-Solvent

Example 2 Membrane 1:

From PAN-2, a 10% polymer solution is prepared with a mixture of DMSO with diacetone alcohol (ratio 3/1). The solution with dynamic viscosity of 10.9 Pa*s is left to stand overnight for degassing and applied on a PET nonwoven on a membrane-drawing machine with a gap of 200 μm and precipitated in water of 24° C. It is washed for 80 min at 40° C. and for a further 50 min at 95° C. The membrane is dried at 105° C. for 3 h. The membrane had an N2 flow of 340 m³/[m²*h*bar], an average pore size at the bubble point of 42 nm (+/−2 nm) and an average pore size of 26 nm (+/−1 nm).

Example 2 Membrane 2:

The ratio DMSO/diacetone alcohol was set at 4/1 and a 10% polymer solution made of PAN-2 was prepared. The dynamic viscosity was at 10 Pa*s. A membrane was drawn on the membrane-drawing machine with a gap of 220 μm and it was further treated as above. The dried membrane had an N2 flow of 230 m³/[m²*h*bar], an average pore size at the bubble point of 108 nm (+/−60 nm) and an average pore size of 31 nm (+/−4 nm).

The higher content of diacetone alcohol produces membranes with a lower bubble point, a lower average pore size and a higher gas flow.

In the SEM, both membranes show an absolute thickness of the foam structure on the surface of 12+/−2 nm and a proportion of approx. 30% foam of the total thickness of the membrane. In FIG. 3a, b, the SEM image of membrane 2 from example 2 is shown.

### Example 3

### Membranes with Ethyl Lactate as Non-Solvent

A 10% polymer solution is prepared from PAN-2 from a mixture of DMSO/ethyl lactate (ratio 84/16). The dynamic viscosity of the solution was 10.9 Pa*s. After filtration and standing for 16 h, a membrane was produced, as in example 2, on a membrane-drawing machine with a gap of 200 μm. The dry membrane had an N₂ flow of 270 m³/[m²*h*bar], an average pore size at the bubble point of 82 nm (+/−43 nm) and an average pore size of 26.1 nm (+/−2.3 nm). The SEM image showed, in cryofracture of the cross-section, a foam structure free of caverns (see FIG. 3a). The surface displays the porosity of the membrane (FIG. 3b).

### Example 4

### Membranes with 1,3-dioxolane and Further Additives as Non-Solvent

As further non-solvent as additive to pouring solutions based on DMSO, 1,3-dioxolane was tested. A similar effect is achieved as by the addition of acetone (example 1), diacetone alcohol (example 2) and ethyl lactate (example 3). However, a higher quantity of non-solvent is required. With 50% addition of 1,3-dioxolane, a foam structure without caverns is extensively achieved. If a part of the non-solvent 1,3-dioxolane is exchanged for TEG or PEG 200 (table 4 PS no. 5-7, 11), the viscosity of the pouring solution is greatly increased from 2.8 Pa*s (PS no. 3, table 4) to 8-9 Pa*s (PS no. 5-7, table 4).

TABLE 4

| | | Poly- | | | |
|---|---|---|---|---|---|
| PS | | mer, | | Ratio | Viscosity, |
| no. | Polymer | % | Solvent mixture | solvent | Pa * s |
| 1 | PAN-1 | 13.0 | DMSO | 100 | 4.0 |
| 2 | PAN-1 | 13.0 | DMSO/1,3-dioxolane | 80/20 | 3.5 |
| 3 | PAN-1 | 13.0 | DMSO/1,3-dioxolane | 50/50 | 2.8 |
| 4 | PAN-1 | 14.0 | DMSO/1,3-dioxolane | 50/50 | 3.8 |
| 5 | PAN-1 | 13.0 | DMSO/1,3-dioxolane/TEG | 60/20/20 | 8.1 |
| 6 | PAN-1 | 13.0 | DMSO/1,3-dioxolane/TEG | 60/20/20 | 8.6 |
| 7 | PAN-1 | 13.0 | DMSO/1,3-dioxolane/PEG | 60/20/20 | 8.9 |
| 8 | PAN-2 | 10.0 | DMSO | 100 | 10.0 |
| 9 | PAN-2 | 10.0 | DMSO/1,3-dioxolane | 47/53 | 10.1 |
| 10 | PAN-2 | 9.5 | DMSO/1,3-dioxolane | 40/60 | — |
| 11 | PAN-2 | 8.9 | DMSO/1,3-dioxolane/TEG | 64/18/18 | — |
| 12 | PAN-2 | 10.0 | DMSO/1,3-dioxolane | 47/53 | 8.5 |
| 13 | PAN-2 | 10.3 | DMSO/1,3-dioxolane | 47/53 | 11.0 |
| 14 | PAN-2 | 10.0 | DMSO/1,3-dioxolane | 50/50 | 9.7 |
| 15 | PAN-2 | 10.0 | DMSO/TEG | 90/10 | 10.9 |

From some of the pouring solutions from table 4, membranes were produced as described under membrane production. The dried, storable membranes were characterised with the porometer and the structure was examined by SEM images. The results are compiled in tables 5 and 6.

TABLE 5

| | | | | | | BP | | |
|---|---|---|---|---|---|---|---|---|
| | | | JN2, | MFP | Standard | pore | Standard | |
| PS no. | Membrane | Gap, | m³/ | size, | deviation | size, | deviation, | |
| (table 4) | no. | μm | (m²*h*bar) | nm | MFP, nm | nm | BP, nm | Polymer |
| 2 | A* | 250 | 11 | — | — | — | — | PAN-1 |
| | (ZM25) | | | | | | | |
| 4 | B | 225 | 350 | 28.1 | 1.7 | 157 | 10 | PAN-1 |
| | (ZM32/1/IV | | | | | | | |
| 5 | C*M119/ | 250 | 1.2 | — | — | — | — | PAN-1 |
| | 120 | | | | | | | |
| 6 | D | 225 | 326 | 24.5 | 0.3 | 165 | 18 | PAN-1 |
| | ZM33/1/IV | | | | | | | |
| 7 | E*M121/122 | 250 | 0.23 | — | — | — | — | PAN-1 |
| 9 | F (ZM36) | 225 | 405 | 22.6 | 1.2 | 30 | 3.5 | PAN-2 |
| 10 | G (ZM49) | 220 | 286 | 22.9 | 0.7 | 34 | 3 | PAN-2 |
| 11 | H (ZM50) | 220 | 313 | 24.5 | 0.3 | 31 | 3 | PAN-2 |
| 12 | I (ZM52) | 225 | 250 | 22.1 | 0.7 | 39 | 11 | PAN-2 |
| 13 | J (ZM59) | 225 | 405 | 24.4 | 0.8 | 63 | 17 | PAN-2 |
| 14 | K (ZM60) | 200 | 310 | 21.3 | 0.5 | 28 | 2 | PAN-2 |
| 15 | L (ZM62) | 200 | 281 | 23.1 | 0.3 | 37 | 7 | PAN-2 |

*Washed only at 40° C.

Membranes made of PAN-1, which were washed only at 40° C., show, after drying, only a low N2 flow of <1-approx. 10 m³/(m²*h*bar). All of the membranes washed at 95° C. deliver gas flows of 250-400 m³/(m²*h*bar). In combination with gas flow, average pore size (MFP) and low bubble point (BP), these membranes are very well suited as underlayer for composite membranes.

By means of SEM analysis, the structure is examined more precisely and the results compiled in table 6.

TABLE 6

| | | | JN2, | Spacing | Membrane | | |
|---|---|---|---|---|---|---|---|
| PS no. | Membrane | Gap, | m³/ | cavern, | thickness, | % | |
| (table 4) | no. | μm | (m²*h*bar) | μm | μm | foam | Polymer |
| 2 | A* | 250 | 11 | 0.7 | 67 | 1 | PAN-1 |
| | (ZM25) | | | | | | |
| 4 | B | 225 | 350 | 4.4 | 46 | 10 | PAN-1 |
| | (ZM32/1/IV) | | | | | | |
| 5 | C* | 250 | 1.2 | 10 | 65 | 16 | PAN-1 |
| | (M119/120) | | | | | | |
| 6 | D | 225 | 326 | 14 | 43 | 32 | PAN-1 |
| | (ZM33/1/IV) | | | | | | |
| 7 | E* | 250 | 0.23 | 10 | 69 | 14 | PAN-1 |
| | (M121/122) | | | | | | |
| 9 | F (ZM36) | 225 | 405 | 37 | 37 | 100 | PAN-2 |
| 10 | G (ZM49) | 220 | 286 | 10 | 20 | >50 | PAN-2 |
| 11 | H (ZM50) | 220 | 313 | 15 | 30 | >50 | PAN-2 |
| 12 | I (ZM52) | 225 | 250 | 17 | 40 | >40 | PAN-2 |
| 13 | J (ZM59) | 225 | 405 | 17 | 43 | >40 | PAN-2 |
| 14 | K (ZM60) | 200 | 310 | 15 | 42 | 36 | PAN-2 |
| 15 | L (ZM62) | 200 | 281 | 10 | 48 | 20 | PAN-2 |

*Washed only at 40° C.

A membrane made of PAN-1 and a 1,3-dioxolane content of 20%, with very large caverns and only a <1 μm thick top layer, is obtained by washing at 40° C. (membrane A, table 6). If the 1,3-dioxolane content is increased to 50% and the polymer concentration to 14% and if it is in addition washed at 95° C., the thickness of the foam-like top layer is increased to >4 μm with a membrane thickness of 46 μm (membrane B, table 6 and FIG. 5a). By the addition of TEG to the pouring solution (PS 6, table 4) and production of the membrane according to the standard conditions, a membrane type with very few caverns is obtained (membrane D, tables 5, 6 and FIG. 5b). The thickness of this membrane is 43 μm and has a proportion of foam of 30%.

A similar effect is achieved by the exchange of TEG for PEG200 (see table 6, membrane E).

When using PAN-2 as membrane former, the viscosity of the pouring solution made of pure DMSO and DMSO/1,3-dioxolane (47/53) is at 10 Pa*s (see table 4, PS 8, 9). However, a membrane with purely a foam structure is obtained only by the addition of 1,3-dioxolane. The cross-section of the membrane F (table 6) and the surface are illustrated in FIG. 6a, b.

By varying the 1,3-dioxolane content and the addition of TEG (PS 10-14, table 4; membranes G-K, tables 5, 6), membranes with foam structures of 40->50% are obtained. A membrane of a typical structure (membrane I, tables 5, 6) is illustrated in FIG. 7a, b.

By the addition of TEG alone without 1,3-dioxolane, membranes with an approx. 20% foam structure are obtained (see tables 5, 6, membrane L) which, in MFP and BP, largely correspond to the values of the membranes with a 1,3-dioxolane proportion.

The N₂ flows of the membranes from example 4, produced according to the general specification, are in the range of 250-400 m³/(m²*h*bar). The MFP is, with membranes made of PAN-2, at 21 to 24.5 nm and the BP generally around 30 nm, with only low scattering evident in the standard deviation of the BP from table 5. Good pressure resistance of the membrane is provided by the extensive foam structure. Hence, these membranes are very well suited as underlayer for composite membranes.

In the following examples, the membranes were produced as described previously under membrane production, however the washing process was changed.

### Example 5

### Membranes Made of DMSO and 1,3-dioxolane Reproducibility

Three pouring solutions were produced from 52.5 g PAN-2, 223.8 g DMSO and 248.8 g 1,3-dioxolane. Membranes were produced therefrom, as described under membrane production, with a gap of 200 μm and at a rate of 1 m/min. Membranes of 0.3 m width and approx. 6 m length were obtained. The membrane rolls were washed in a washer and dried in a drying oven for 16 h at 85° C. From the dry membrane, bubble point, average pore size and N₂ flow were determined with the porometer.

The concentrations, the mixing ratio of the solvents and the viscosity of the pouring solution are shown in table 7. Table 8 describes the washing conditions of the membranes, table 9 shows the measured porometer data, namely bubble point, pore size and N2 flow of the dried membranes.

TABLE 7

| PS | | | | Solvent | Viscosity, |
|---|---|---|---|---|---|
| no. | Polymer | Polymer, % | Solvent mixture | ratio | Pa * s |
| 1 | PAN-2 | 10.0 | DMSO/1,3-dioxolane | 47/53 | 8.10 |
| 2 | PAN-2 | 10.0 | DMSO/1,3-dioxolane | 47/53 | 8.55 |
| 3 | PAN-2 | 10.0 | DMSO/1,3-dioxolane | 47/53 | 8.46 |

TABLE 8

| | Inflow | | | |
|---|---|---|---|---|
| PS | temperature, | Washing bath | Outflow | Time in the |
| no. | ° C. | temperature, ° C. | temperature, ° C. | washer, min |
| 1 | 90 | 74 | 72 | 40 |
| 2 | 91 | 78 | 75 | 40 |
| 3 | 75 | 68 | 62 | 40 |

TABLE 9

| Membrane made of | Bubble | Average pore | N₂ flow, |
|---|---|---|---|
| PS no. | Point, nm | size, nm | m³/m² * h * bar |
| 1 | 23.4 +/− 0.9 | 18.9 +/− 0.1 | 300 +/− 14 |
| 2 | 22.3 +/− 0.8 | 17.6 +/− 0.5 | 300 +/− 26 |
| 3 | 21.9 +/− 1.4 | 17.7 +/− 0.5 | 260 +/− 47 |

In addition to the washing process, the membranes can also be temperature-controlled at 90-95° C. for half an hour in order to increase the pressure stability.

The pore size, bubble point and gas permeability are not thereby changed.

A high-resolution scanning electron micrograph of the membrane made of PS no. 3, table 9 is shown in FIG. 8. Regular pores are found, the average size of which is found to be between 7.7 and 13.8 nm according to the model which is used.

With these pouring solutions, membranes with an average pore size of 18-19 nm are obtained, which have a bubble point of 22-23 nm. The gas permeability is at approx. 300 m³/m²*h*bar and stands for high porosity. Membranes of this type are very well suited as carrier membranes for composite membranes with a high gas- or vapour throughput.

1-18. (canceled)

19. A method for the production of a polymer membrane, in which a solution comprising:
a) poly(meth)acrylonitrile, a copolymer based on (meth)acrylonitrile, or a mixture thereof,
b) dimethylsulphoxide (DMSO) as solvent for poly(meth)acrylonitrile or a copolymer based on (meth)acrylonitrile, and
c) at least one non-solvent in which poly(meth)acrylonitrile or the copolymer based on (meth)acrylonitrile does not dissolve and which is miscible with the solvent,
the solution being free of crosslinkers for poly(meth)acrylonitrile or copolymers based on poly(meth)acrylonitrile,
being poured as a film or spun to form a hollow fibre,
the poly(meth)acrylonitrile, copolymer based on (meth)acrylonitrile, or the mixture thereof being precipitated by a phase-inversion process,
and the poly(meth)acrylonitrile, copolymer based on (meth)acrylonitrile, or the mixture thereof being stabilised by heat treatment at temperatures increased relative to room temperature.

20. The method according to claim 19, wherein the non-solvent is selected from the group consisting of acetone, diacetone alcohol, ethyl lactate, 1,3-dioxolane, polyalkylene glycol, alcohols, water and mixtures thereof.

21. The method according to claim 19, wherein the film is poured onto a substrate.

22. The method according to claim 19, wherein the film or hollow fibre obtained after the phase-inversion process is washed with water.

23. The method according to claim 19, wherein the heat treatment is effected at temperatures of 50 to 150° C., subsequent to the phase-inversion process, with water and/or over period of time of 5 min to 24 hours.

24. The method according to claim 19, wherein, after crosslinking and/or or washing, drying of the membrane is implemented.

25. The polymer membrane produced according to the method of claim 19, which is in the form of a flat membrane or hollow fibre membrane.

26. The polymer membrane according to claim 25, wherein the thickness of the membrane, without any possibly present substrate, is of 20 to 200 μm.

27. The polymer membrane according to claim 25, wherein the pore size of the membrane at the bubble point is of 15 to 100 nm.

28. The polymer membrane according to claim 25, wherein the average pore size of the membrane is 15 to 30 nm.

29. The polymer membrane according to claim 25, which has a nitrogen permeability J_{N2} of 10 to 1,000 m³/(m²·h·bar).

30. The polymer membrane according to claim 25, which has a foam structure.

31. A solution for the production of a polymer membrane, comprising
a) poly(meth)acrylonitrile, a copolymer based on (meth)acrylonitrile or a mixture thereof,
b) at least one solvent for poly(meth)acrylonitrile or a copolymer based on (meth)acrylonitrile in which the previously mentioned components are present in dissolved state; and
c) at least one non-solvent in which poly(meth)acrylonitrile or the copolymer based on (meth)acrylonitrile does not dissolve and which is miscible with the solvent, the solution being free of crosslinkers for poly(meth)acrylonitrile or copolymers based on poly(meth)acrylonitrile.

32. The solution according to claim 31, wherein the non-solvent is selected from the group consisting of acetone, diacetone alcohol, ethyl lactate, 1,3-dioxolane, polyalkylene glycol, alcohols, water, and mixtures thereof.

33. The solution according to claim 31, wherein the total content of poly(meth)acrylonitrile, of the copolymer based on (meth)acrylonitrile or mixtures thereof, relative to the sum of solvent and non-solvent is of 1 to 30% by weight.

34. The solution according to claim 31, wherein the content of non-solvent, relative to the content of solvent or of the mixture of at least two solvents is 10 to 60% by weight.

35. The solution according to claim 31, wherein the copolymer based on (meth)acrylonitrile is obtained by copolymerisation of (meth)acrylonitrile with at least one copolymer selected from the group consisting of (meth)allyl sulphonic acid or the salts thereof.

36. The solution according to claim 31, which has a viscosity of 1.5 to 20 Pa·s.
